(19) United States
(12) Patent Application Publication
(10) Pub. No.: US 2012/0240577 A1
(43) Pub. Date: Sep. 27, 2012

(54) THERMAL GENERATION SYSTEMS

(75) Inventors: Eli Mandelberg, Tel Aviv (IL); Ory Zik, Brookline, MA (US)

(73) Assignee: Heliofocus Ltd., Ziona (IL)

(21) Appl. No.: 13/513,580

(22) PCT Filed: Dec. 6, 2010
(86) PCT No.: PCT/IL10/01030

§ 371 Date: Jun. 3, 2012

Related U.S. Application Data
(60) Provisional application No. 61/267,067, filed on Dec. 6, 2009.

(51) Int. Cl. F03G 6/06; F03G 7/00

(52) U.S. Cl. 60/641.15; 60/641.2

(57) ABSTRACT

A thermal generation system including a first renewable energy system operative to heat a first working fluid flowing therein, a second renewable energy system operative to heat a second working fluid flowing therein, and a heat transfer fluid for providing a thermal energy consumption system with thermal energy, the heat transfer fluid being designated to be heated by thermal energy, provided by the heated first working fluid, to a first elevated temperature and the heat transfer fluid being designated to be heated by thermal energy, provided by the heated second working fluid, to a second elevated temperature, wherein the second elevated temperature is greater than the first elevated temperature, the heat transfer fluid entering the thermal energy consumption system at the second elevated temperature.

### REFERENCE TO CO-PENDING APPLICATIONS

Applicant hereby claims priority of U.S. provisional application No. 61/267,067 filed on Dec. 6, 2010, entitled “POWER GENERATION SYSTEMS” which is incorporated herein by reference in its entirety.

### FIELD OF THE INVENTION

The present invention relates generally to thermal generation systems and more particularly to thermal generation systems using renewable energy.

### BACKGROUND OF THE INVENTION

Thermal generation systems that generate thermal energy by combustion of fossil fuels are well known.

Thermal generation systems that generate thermal energy by use of renewable energy sources are gaining recognition. These thermal energy systems exploit renewable energy sources to provide heat to thermal energy consumption systems typically in the form of hot gas, such as air, or heated vapor, such as steam.

### SUMMARY OF THE INVENTION

There is thus provided in accordance with an embodiment of the invention a thermal generation system including a first renewable energy system operative to heat a first working fluid flowing therein, a second renewable energy system operative to heat a second working fluid flowing therein, and a heat transfer fluid for providing a thermal energy consumption system with thermal energy, the heat transfer fluid being designated to be heated by thermal energy, provided by the heated first working fluid, to a first elevated temperature and the heat transfer fluid being designated to be heated by thermal energy, provided by the heated second working fluid, to a second elevated temperature, wherein the second elevated temperature is greater than the first elevated temperature, the heat transfer fluid entering the thermal energy consumption system at the second elevated temperature.

In accordance with an embodiment of the present invention the heat transfer fluid is heated by thermal energy provided by the first working fluid within a first heat exchanger assembly in fluid communication with the first renewable energy system. Additionally, the heat transfer fluid is heated by thermal energy provided by the second working fluid within a second heat exchanger assembly in fluid communication with the second renewable energy system. Furthermore, the heat transfer fluid bypasses the first renewable energy system and is heated within the second renewable energy system.

In accordance with another embodiment of the present invention the first renewable energy system and the second renewable energy system include any one of a solar energy systems, a solar tower system, a Fresnel lens solar energy system, a trough-Fresnel mirror solar energy system, a linear Fresnel solar energy system, a solar dish concentrating energy system, a solar heliostat concentrating energy system, a parabolic trough solar concentrating energy system, a geothermal energy systems, a wind energy system or a wave energy system. Additionally, the thermal energy consumption system is designated to provide thermal energy for a thermal energy consuming system. Furthermore, the thermal energy of the thermal energy consumption system is provided for industrial systems or the thermal energy is utilized for vaporization or pasteurization, or the thermal energy is used for drying, or the thermal energy is used for drying polymer containing products, or the thermal energy is introduced into a vapor turbine for generation of electricity therefrom or the thermal energy is provided to boost a vapor turbine, or the thermal energy provides vapor to systems consuming vapor, or the thermal energy is utilized for direct heating of a solid desiccant system, a desiccant system included in an air conditioning system or the thermal energy is used for absorption cooling.

In accordance with yet another embodiment of the present invention the first renewable energy system includes a single axis Sun tracking solar concentrating system and the second renewable energy system includes a dual axis Sun tracking solar concentrating system. Additionally, the second renewable energy system includes a solar concentrating system including at least one dish and at least one solar receiver.

There is thus provided in accordance with another embodiment of the invention a method for providing thermal energy to a thermal energy consumption system including heating a first working fluid flowing within a first renewable energy system, heating a second working fluid flowing within a second renewable energy system, heating a heat transfer fluid, flowing within the thermal energy consumption system, by thermal energy provided by the heated first working fluid, to a first elevated temperature, heating the heat transfer fluid by thermal energy, provided by the heated second working fluid, to a second elevated temperature, wherein the second elevated temperature is greater than the first elevated temperature, and introducing the heat transfer fluid at the second elevated temperature into the thermal energy consumption system, thereby providing thermal energy thereto.

There is thus provided in accordance with yet another embodiment of the invention a thermal generation system including a vapor power generating system including a heat transfer fluid to be expended within a turbine for generation of electricity therefrom, a parabolic trough solar concentrating system designed to provide thermal energy to the heat transfer fluid so as to heat the heat transfer fluid to a first elevated temperature, and an auxiliary solar concentrating system operative to provide thermal energy to the heat transfer fluid so as to further heat the heat transfer fluid to a second elevated temperature, the second elevated temperature being greater than the first elevated temperature, the heat transfer fluid entering the turbine at the second elevated temperature.

In accordance with an embodiment of the present invention the auxiliary solar concentrating system includes a dish concentrator and a solar receiver. Alternatively, the auxiliary solar concentrating system includes a plurality of dish concentrators and solar receivers. Additionally, at least one compressor and at least one additional turbine are provided.

In accordance with another embodiment of the present invention the heat transfer fluid is heated by thermal energy, provided by the parabolic trough solar concentrating system, by a trough system working fluid flowing within the parabolic trough solar concentrating system, and the heat transfer fluid is heated by thermal energy, provided by the auxiliary solar concentrating system, by an auxiliary working fluid flowing within the auxiliary solar concentrating system. Additionally, the heat transfer fluid is heated by thermal energy provided by the trough system working fluid, flowing within a first heat exchanger assembly, and the heat transfer fluid is heated by thermal energy provided by the auxiliary working fluid, flowing within a second heat exchanger assembly.

In accordance with yet another embodiment, of the present invention the first heat exchanger assembly includes a preheater, a steam generator and/or a superheater. Additionally, the second heat exchanger assembly includes a primary superheater. Moreover, the second heat exchanger assembly includes a preheater, a steam generator and/or an additional superheater. Furthermore, the heat transfer fluid flows from the turbine to the first heat exchanger assembly and thereafter to the primary superheater within the second heat exchanger assembly. Alternatively, the heat transfer fluid flows from the turbine to the preheater of the second heat exchanger assembly.

In accordance with still another embodiment of the present invention the parabolic trough solar concentrating system includes a parabolic trough reflector provided to concentrate solar radiation onto tubes.

There is thus provided in accordance with still another embodiment of the invention a method for providing thermal energy to a thermal energy consumption system including heating a trough system working fluid flowing within a parabolic trough solar concentrating system, heating an auxiliary working fluid flowing within an auxiliary solar concentrating system, heating a heat transfer fluid, flowing within the thermal energy consumption system, by thermal energy provided by the heated trough system working fluid, to a first elevated temperature, heating the heat transfer fluid by thermal energy provided by the heated auxiliary working fluid to a second elevated temperature, wherein the second elevated temperature is greater than the first elevated temperature, and introducing the heat transfer fluid at the second elevated temperature into the thermal energy consumption system, thereby providing thermal energy thereto.

In accordance with an embodiment of the present invention the thermal energy consumption system includes a turbine and the heat transfer fluid is expanded therein, thereby generating electricity.

There is thus provided in accordance with a further embodiment of the invention a thermal generation system including a vapor power generating system including a heat transfer fluid to be expended within a turbine for generation of electricity therefrom, a linear Fresnel solar energy system designed to provide thermal energy to the heat transfer fluid so as to heat the heat transfer fluid to a first elevated temperature, and a solar tower system operative to provide thermal energy to the heat transfer fluid so as to further heat the heat transfer fluid to a second elevated temperature, the second elevated temperature being greater than the first elevated temperature, the heat transfer fluid entering the turbine at the second elevated temperature.

In accordance with an embodiment of the present invention the linear Fresnel solar energy system includes at least one linear Fresnel reflector provided to concentrate solar radiation onto at least one receiver. Additionally, the solar tower system includes a solar receiver located on a tower, operative to heat a solar tower working fluid by concentrated solar radiation, the solar radiation being concentrated by an array of heliostats.

There is thus provided in accordance with yet a further embodiment of the invention a thermal generation system including a single axis Sun tracking solar concentrating system including a solar concentrator for concentrating solar radiation so as to heat a first working fluid flowing therein, the single axis Sun tracking solar concentrating system being operative to follow the Sun by tracking along a single axis of the single axis Sun tracking solar concentrating system, a plural axis Sun tracking solar concentrating system including a solar concentrator for concentrating solar radiation so as to heat a second working fluid flowing therein, the plural axis Sun tracking solar concentrating system being operative to follow the Sun by tracking along at least two axes of the plural axis Sun tracking solar concentrating system, and a heat transfer fluid for providing a thermal energy consumption system with thermal energy, the heat transfer fluid being designated to be heated by thermal energy, provided by the heated first working fluid, to a first elevated temperature and the heat transfer fluid being designated to be heated by thermal energy, provided by the heated second working fluid, to a second elevated temperature, the heat transfer fluid entering the thermal energy consumption system at the second elevated temperature.

In accordance with an embodiment of the present invention the second elevated temperature is greater than the first elevated temperature. Additionally, the single axis Sun tracking solar concentrating system includes a parabolic trough solar concentrating system and the plural axis Sun tracking solar concentrating system includes a solar concentrating system including at least one dish and at least one solar receiver.

There is thus provided in accordance with still a further embodiment of the invention a method for providing thermal energy to a thermal energy consumption system including heating a first working fluid flowing within a single axis Sun tracking solar concentrating system, heating a second working fluid flowing within a plural axis Sun tracking solar concentrating system, heating a heat transfer fluid, flowing within the thermal energy consumption system, by thermal energy provided by the heated first working fluid, to a first elevated temperature, heating the heat transfer fluid, by thermal energy provided by the heated second working fluid, to a second elevated temperature, and introducing the heat transfer fluid at the second elevated temperature into the thermal energy consumption system, thereby providing thermal energy thereto.

In accordance with an embodiment of the present invention the second elevated temperature is greater than the first elevated temperature.

### BRIEF DESCRIPTION OF THE DRAWING

The present subject matter will be understood and appreciated more fully from the following detailed description, taken in conjunction with the drawings in which:

FIG. 1 is a simplified schematic illustration of a thermal generation system, constructed and operative in accordance with an embodiment of the present invention;

FIG. 2 is a simplified schematic illustration of a thermal generation system, constructed and operative in accordance with another embodiment of the present invention;

FIG. 3 is a simplified schematic illustration of a thermal generation system constructed and operative in accordance with yet another embodiment of the present invention; and

FIG. 4 is a simplified schematic illustration of a thermal generation system constructed and operative in accordance with still another embodiment of the present invention

### DETAILED DESCRIPTION OF EMBODIMENTS

In the following description, various aspects of the present subject matter will be described. For purposes of explanation, specific configurations and details are set forth in order to provide a thorough understanding of the present subject matter. However, it will also be apparent to one skilled in the art that the present subject matter may be practiced without specific details presented herein without departing from the scope of the present invention. Furthermore, the description omits and/or simplifies some well known features in order not to obscure the description of the subject matter.

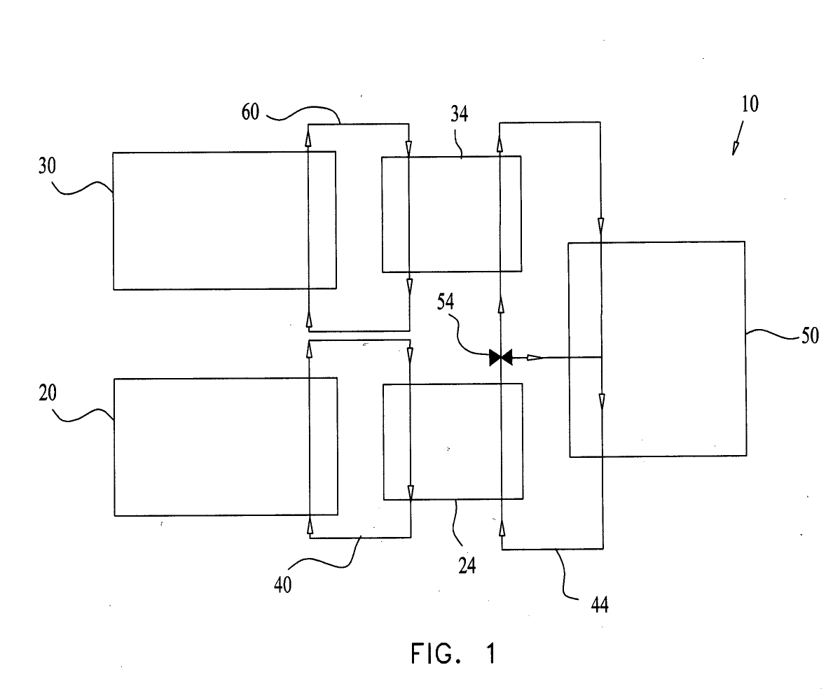

Reference is now made to FIG. 1, which is a simplified schematic illustration of a thermal generation system, constructed and operative in accordance with an embodiment of the present invention. As seen in FIG. 1, a thermal generation system 10 comprises a first renewable energy system 20 in fluid communication with a first heat exchanger assembly 24 and a second renewable energy system 30 in fluid communication with a second heat exchanger assembly 34.

The first and second renewable energy systems 20 and 30, respectively, may be any suitable system designated to provide thermal energy by exploiting renewable energy sources. Examples of renewable energy systems are solar energy systems, geothermal energy systems, wind or wave energy systems. The solar energy system may be any solar energy system, such as a solar tower system, Fresnel lens solar energy system, and a trough-Fresnel mirror solar energy system, a linear Fresnel solar energy system, a solar dish concentrating energy system, a solar heliostat concentrating energy system and a parabolic trough solar concentrating energy system or any solar concentrating system, for example.

A first working fluid 40 may flow into the first renewable energy system 20 at an initial temperature so as to be heated therein and exit therefrom at a higher temperature than the initial temperature. The first working fluid 40 flows into the first heat exchanger assembly 24 thereby heating a heat transfer fluid 44 flowing oppositely in the first heat exchanger 24. The heat transfer fluid 44 is heated by the first working fluid 40 to a first elevated temperature.

The heat transfer fluid 44 may flow to a thermal energy consumption system 50 via a valve 54 so as to provide the thermal energy consumption system 50 with thermal energy within the heat transfer fluid 44.

The thermal energy consumption system 50 is designated to provide thermal energy for any thermal energy consuming system. In a non-limiting example, thermal energy consumption system 50 may provide thermal energy for industrial systems, such as for the food industry. Moreover, the thermal energy may be utilized for vaporization, pasteurization or any other heat consuming process used in the chemical industry or other industries. The thermal energy may be used for drying, such as drying polymer containing products, for example. The thermal energy may be introduced into a vapor turbine for generation of electricity therefrom. Additionally, the thermal energy may be provided to boost a vapor turbine, typically a steam turbine, such as a coal or gas fuel fired steam turbine or a steam turbine included in a combined cycle-gas fired system. Furthermore, the thermal energy may provide vapor to systems consuming vapor, such as steam. The thermal energy may also be utilized for direct heating of a solid desiccant system, such as a desiccant system included in an air conditioning system. The thermal energy may be used for absorption cooling such as by steam or heated air, for example.

It is noted that thermal storage functionality, such as a high temperature thermal storage device may be provided to allow storage of the heat transfer fluid 44 for use in the thermal energy consumption system 50.

It is a particular feature of the present invention that the heat transfer fluid 44 may flow from first heat exchanger assembly 24 at the first elevated temperature via valve 54 to the second heat exchanger 34 so as to be further heated therein.

A second working fluid 60 may flow into the second renewable energy system 30 at an initial temperature so as to be heated therein and exit therefrom at a higher temperature than the initial temperature. The second working fluid 60 flows into the second heat exchanger assembly 34 thereby heating the heat transfer fluid 44 flowing oppositely in the second heat exchanger 34. The heat transfer fluid 44 is heated by the second working fluid 60 to a second elevated temperature.

The second renewable energy system 30 is designated to heat the second working fluid 60 flowing therein, such that the temperature of the second working fluid 60 exiting the second renewable energy system 30 is greater than the temperature of the first working fluid 40 exiting the first renewable energy system 20. Thus, the heat transfer fluid 44 enters the second heat exchanger 34 at the first elevated temperature and is heated therein by the oppositely flowing second working fluid 60 to an increased second elevated temperature, which is higher than the first elevated temperature.

The heat transfer fluid 44 may flow to the thermal energy consumption system 50 at the second elevated temperature so as to provide the thermal energy consumption system 50 with thermal energy provided by the heat transfer fluid 44.

The first working fluid 40, second working fluid 60 and heat transfer fluid 44 may be any suitable fluid such as a gas, typically air or carbon dioxide, or a liquid, such as water, oil or molten salt, for example.

In the embodiment shown in FIG. 1, first and second renewable energy systems 20 and 30, respectively, comprise a closed loop cycle, though it is appreciated that an open loop cycle may be utilized.

It is appreciated that the thermal generation system 10 may comprise additional renewable energy systems wherein each consecutive renewable energy systems is designated to heat a working fluid flowing therein to a temperature higher than a temperature of a working fluid exiting a previous renewable energy systems. The heat transfer fluid may thus be heated by each consecutive working fluid to an elevated temperature.

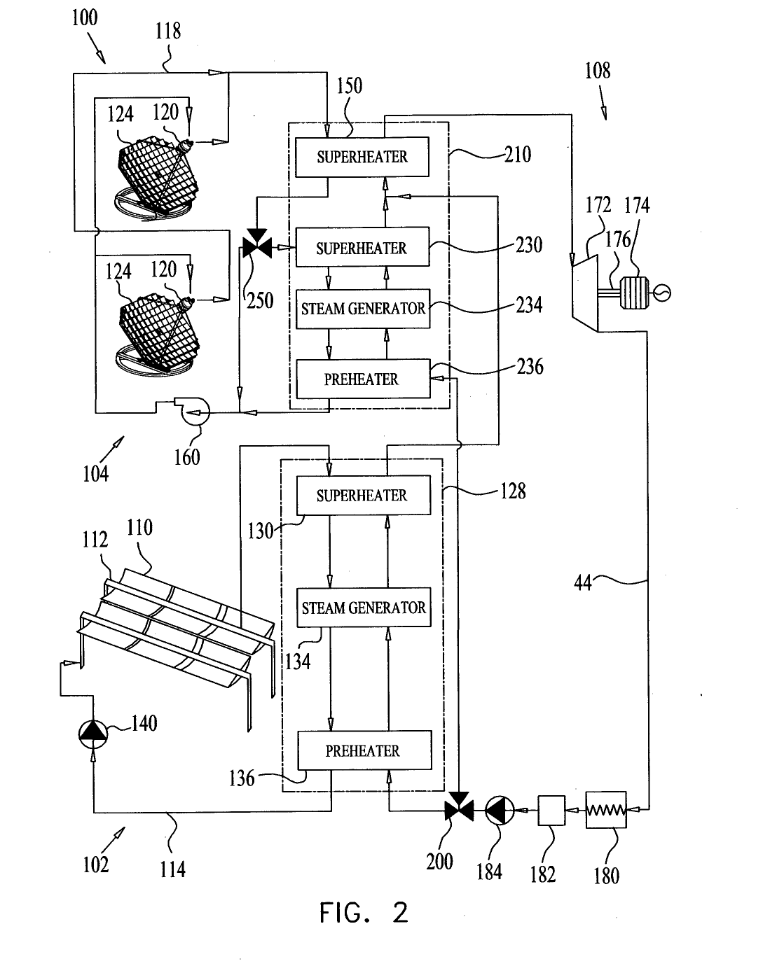

In the following FIGS. 2-4 various embodiments of the thermal generation system 10 are describes. It is appreciated that these embodiments are provided as non-limiting examples and the thermal generation system 10 may be realized in many other ways.

As seen in FIG. 2, the thermal generation system 10 comprises a solar cycle system 100. The first renewable energy system 20 comprises a parabolic trough solar concentrating system 102. The second renewable energy system 30 comprises an auxiliary solar concentrating system 104. The trough system 102 and auxiliary solar concentrating system 104 are in fluid communication with the thermal energy consumption system 50 comprising a vapor power generating system 108 for generating electricity therefrom.

The trough system 102 may be a standard parabolic trough solar concentrating system typically comprising a parabolic trough reflector 110 provided to concentrate solar radiation onto receivers. The receivers are generally formed as tubes 112. Within tubes 112 flows the first working fluid 40 comprising a trough system working fluid 114 flowing therein and heated thereby by concentrated solar radiation. The trough system working fluid 114 may be any suitable fluid, typically water, oil or molten salt, for example.

The parabolic trough reflector 110 is typically a single axis Sun tracking solar concentrating system operative to follow the Sun during daylight hours by tracking along a single axis of the trough system 102.

The trough system working fluid 114 flows into the trough system 102 at an initial entrance temperature so as to be heated therein and exit therefrom at a higher exit temperature than the entrance temperature.

In some standard parabolic trough solar concentrating systems the working fluid temperature is elevated by the solar radiation to an increased exit temperature, generally in the range of approximately 350-400° C.

It is appreciated that trough system 102 may be replaced by any suitable system utilizing renewable energy, as described hereinabove in reference to FIG. 1.

The auxiliary solar concentrating system 104 may comprise any suitable system utilizing renewable energy, as described hereinabove. For example, the auxiliary solar concentrating system 104 may be any suitable solar concentrating system. The solar concentrating system is operative to heat the second working fluid 60, comprising an auxiliary working fluid 118, flowing therein at an initial entrance temperature. The auxiliary working fluid 118 is heated by concentrated solar radiation and exits therefrom at a higher exit temperature than the entrance temperature.

The solar concentrating system 104 may comprise a sun-tracking concentrator or an array of sun-tracking mirrors. The solar concentrating system 104 is a plural or dual axis Sun tracking solar concentrating system operative to follow the Sun by tracking along at least two axes of the solar concentrating system.

In a non-limiting example, as seen in FIG. 2, the solar concentrating system 104 comprises a solar receiver 120 operative to heat the auxiliary working fluid 118 by concentrated solar radiation. The solar radiation may be concentrated by any suitable means, such as by a dish 124. The dish 124 may be designed to follow the Sun by tracking along two axes thereof.

Any suitable auxiliary working fluid 118 may flow within the auxiliary solar concentrating system 104, such as a gas, typically air or carbon dioxide, or a liquid such as oil, water or molten salt, for example. Wherein the auxiliary working fluid 118 is a liquid, such as molten salt, oil or water, the receiver 120 may typically be a tubular receiver operative to heat the liquid therein. Alternatively, the receiver 120 may typically be a volumetric receiver wherein the auxiliary working fluid 118 is a gas, such as air or carbon dioxide.

The solar concentrating system 104 may comprise a single receiver 120 and dish 124 or a plurality of receivers and dishes, as shown in FIG. 2. In the embodiment shown in FIG. 2, the solar concentrating system 104 comprises a closed loop cycle, though it is appreciated that an open loop cycle may be utilized.

The trough system 102 and the solar concentrating system 104 are both in fluid communication with the vapor power generating system 108 for producing electricity therefrom. The heat transfer fluid 44 flows within the vapor power generating system 108 and is heated by thermal energy provided by the heated trough working fluid 114 of trough system 102 and/or the heated auxiliary working fluid 118 of the solar concentrating system 104.

The heat transfer fluid 44 flowing within the vapor power generating system 108 may be any suitable fluid such as a liquid, typically water, oil or molten salt. Alternatively, the heat transfer fluid 44 may be a gas, such as air or carbon dioxide. In the embodiment shown in FIG. 2, the heat transfer fluid 44 is water.

The trough working fluid 114 enters the tubes 112 of the trough system 102 at an initial entrance temperature and is heated by solar radiation concentrated by the parabolic trough reflector 110. The trough working fluid 114 flows out of the trough system 102 at an exit temperature higher than the initial entrance temperature. The trough working fluid 114 thereafter enters the first heat exchanger 24 comprising a first heat exchanger assembly 128. The first heat exchanger assembly 128 may comprise a superheater 130, a steam generator 134 and/or a preheater 136 so as to transfer thermal energy and thereby heat the heat transfer fluid 44, flowing oppositely in the preheater 136, the steam generator 134 and/or the superheater 130, to a first elevated temperature.

The trough working fluid 114 exiting the preheater 130 may flow back into tubes 112 via a pump 140, thereby allowing the trough working fluid 114 to flow continuously. Pump 140 may be obviated.

The auxiliary working fluid 118 enters at least one receiver 120 or a plurality of receivers 120 at an initial entrance temperature and is heated therein by concentrated solar radiation. The auxiliary working fluid 118 exits the receivers 120 at an exit temperature higher than the initial entrance temperature and flows into a primary superheater 150 thereby further heating the steam to a second elevated temperature. The auxiliary working fluid 118 exits the superheater 150 and mayflow back to the receivers 120 via a blower 160, typically wherein the auxiliary working fluid 118 is air, thereby allowing the auxiliary working fluid 118 to flow continuously. Blower 160 may be obviated.

The vapor power generating system 108 may comprise a steam turbine 172. The steam enters the steam turbine 172 and is expended therein. In turn the steam turbine 172 drives a generator 174 via a shaft 176 for producing electrical energy therefrom.

The steam, generally at near saturation point, exits the steam turbine 172 and flows on to a condenser 180 wherein the steam undergoes condensation to water.

An additional heating element 182, operative to further heat the water by any suitable means, may be provided.

The water exiting the condenser 180 and/or heating element 182 may be introduced into preheater 136 via a pump 184 thereby allowing the water of vapor power generating system 108 to flow continuously. Pump 184 may be obviated.

As seen in FIG. 2, the water may enter preheater 136 via a valve 200. The valve 200 is provided to allow the water to flow into preheater 136 or to bypass the heat exchanger assembly 128 and flow directly into the second heat exchanger 34 comprising a second heat exchanger assembly 210. Alternatively, the water may flow via valve 200 partially into first heat exchanger assembly 128 and partially into second heat exchanger assembly 210.

Valve 200 may be provided to allow the water to bypass or only partially flow within first heat exchanger assembly 128, typically at times the actual effective solar radiation on an aperture surface of the trough reflector 110 is reduced from its maximal design point radiation level. This typically occurs during winter months and transitional seasons wherein the sun incident angle is lower than its perpendicular position, which is a function of a site location latitude and the time of year.

The second heat exchanger assembly 210 is in fluid communication with solar concentrating system 104 and may comprise primary superheater 150 and an additional superheater 230, a steam generator 234 and/or a preheater 236.

The water flowing into second heat exchanger assembly 210, via valve 200, may be heated within the preheater 236, steam generator 234 and superheater 230.

As described hereinabove the auxiliary working fluid 118 may flow from superheater 150 back to solar concentrating system 104. The auxiliary working fluid 118 may flow directly into solar concentrating system 104 via a valve 250 provided to allow the auxiliary working fluid 118 to flow directly into solar concentrating system 104 or into superheater 230 and thereafter to steam generator 234 and preheater 236 so as to heat the incoming water flowing via the preheater 236, steam generator 234 and superheater 230, as described hereinabove. Alternatively, the auxiliary working fluid 118 may flow, partially into the superheater 230 and thereafter to steam generator 234 and preheater 236, and partially into the solar concentrating system 104.

The superheaters 130, 150 and 230 may be any standard superheater. The steam generators 134 and 234 may be any standard steam generator. The preheaters 136 and 236 may be any standard preheater.

It is noted that additional heating elements, such as reheaters and recuperators (not shown) may be included within first heat exchanger assembly 128 and/or second heat exchanger assembly 210.

Thus it is seen that heating of steam of the vapor power generating system 108, by thermal energy provided by the trough system 102, to a first elevated temperature and thereafter further heating the steam, by thermal energy provided by the auxiliary solar concentrating system 104, to a greater second elevated temperature, allows for the steam to enter the steam turbine 172 at a relatively high temperature. This provides for increased operative efficiency of the steam turbine 172 due to the elevated temperature of the steam entering therein.

In a non-limiting example further heating of the steam by thermal energy provided by the auxiliary solar concentrating system 104 may raise the solar system cycle efficiency from 36% to 42% thereby increasing the electrical capacity of the solar cycle system 100 from 100 Mega Watt to 116 Mega Watt. In a non-limiting example the trough working fluid 114 is an oil, which enters the superheater 130 at a first elevated temperature of approximately 395° C. and a pressure of approximately 40 bar and exits at a lowered temperature of approximately 382° C. and a pressure of approximately 38 bar. Thereafter the trough working fluid 114 enters the steam generator 134 and exits at a lowered temperature of approximately 321° C. and a pressure of approximately 36 bar. Thereafter the trough working fluid 114 enters the preheater 136 and exits at a lowered temperature of approximately 295° C. and a pressure of approximately 34 bar. The water enters the preheater 136 at a temperature of approximately 240° C. and a pressure of approximately 72.5 bar. The water exits the preheater 136 at an elevated temperature of approximately 286° C. and a pressure of approximately 72 bar and is vaporized to steam at a temperature of approximately 286° C. and a pressure of approximately 71 bar within the steam generator 134. The steam enters superheater 130 and is heated therein to a first elevated temperature of approximately 370° C. and a pressure of approximately 70.5 bar

The auxiliary working fluid 118 is air, which enters the receivers 120 from the superheater 150 at a temperature of approximately 370° C. and a pressure of approximately 4.5 bar. The auxiliary working fluid enters the superheater 150 at an elevated temperature of approximately 600° C. and a pressure of approximately 4 bar. The steam entering superheater 150 exits therefrom at a second elevated temperature of approximately 540° C. and a pressure of approximately 70 bar.

The temperature of the steam exiting steam turbine 172 is approximately 40° C. and the pressure is approximately 0.074 bar. The water exits the condenser 180 substantiality at the temperature and pressure of the steam entering the condenser 180, thus in the embodiment shown in FIG. 2, the temperature of the water exiting condenser 180 is approximately 40° C. and the pressure is approximately 0.074 bar.

The water may enter heat exchanger assembly 210 at the preheater 236, after being heated within heating element 182, at a temperature of approximately 240° C. and a pressure of approximately 72.5 bar. The water exits the preheater 236 at an elevated temperature of approximately 286° C. and a pressure of approximately 72 bar and is vaporized to steam of approximately 286° C. and a pressure of approximately 71 bar within the steam generator 234. The steam enters superheater 230 and is heated therein to an elevated temperature of approximately 370° C. and a pressure of approximately 70.5 bar. The steam enters superheater 150 for further heating thereof prior to entering turbine 172.

The auxiliary working fluid 118 exits the superheater 150 and enters the superheater 230 at a temperature of approximately 380° C. and exits at a lowered temperature of approximately 370° C. Thereafter the auxiliary working fluid enters the steam generator 234 and exits at a lowered temperature in the range of approximately 290-300° C. Thereafter the auxiliary working fluid enters the preheater 236 and exits at a lowered temperature of approximately 260° C.

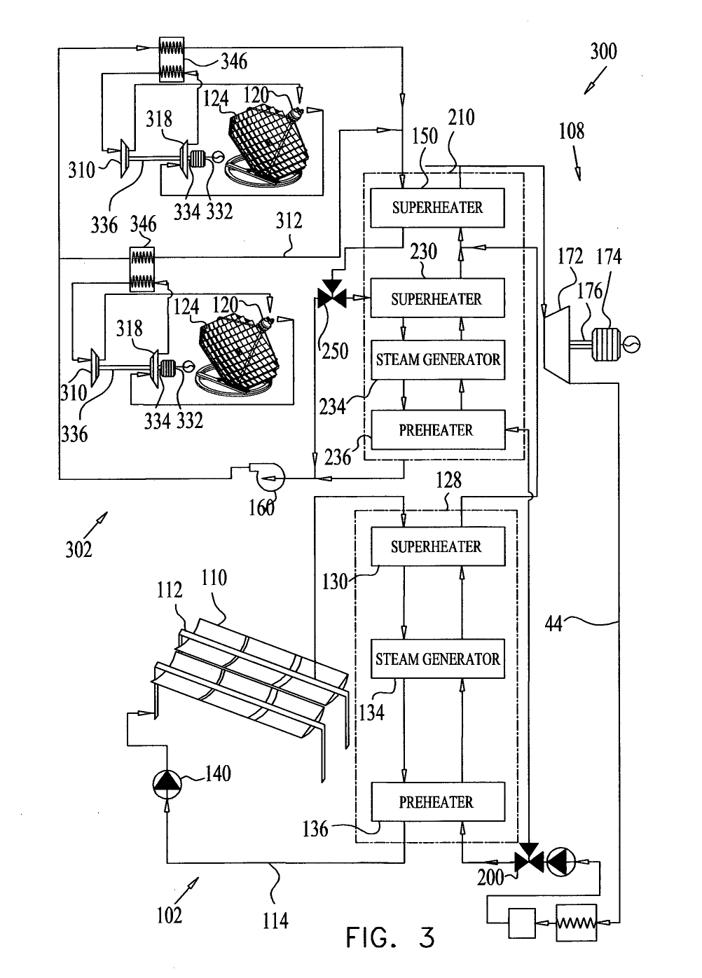

As seen in FIG. 3, the thermal generation system 10 comprises a solar cycle system 300. The trough system 102 and the vapor power generating system 108 are as in FIG. 2. The auxiliary solar concentrating system, here designated by reference numeral 302, comprises a compressor 310 for allowing an incoming auxiliary working fluid 312, such as air, to flow therein.

Compressed auxiliary working fluid 312 flows out of compressor 310 typically at an elevated pressure. The compressed auxiliary working fluid 312 flows on to solar receiver 120. Auxiliary working fluid 312 exiting the solar receiver 120 flows into a turbine expander 318, which expands the auxiliary working fluid 312 and drives a generator 332 via a shaft 334 for producing electrical energy therefrom.

It is appreciated that in the embodiment of the present invention shown in FIG. 3 the compressor 310 is coupled to turbine expander 318 via a coupling shaft 336, though in alternative embodiments the coupling shaft 336 may be obviated.

The expanded auxiliary working fluid 312 exits the turbine expander 318 typically at a lowered temperature.

The expanded auxiliary working fluid 312 enters a recuperator 346 thereby heating the auxiliary working fluid 312 entering recuperator 346 from blower 160. The auxiliary working fluid 312 exits the recuperator 346 at an elevated temperature. The heated auxiliary working fluid 312 flows into superheater 150.

Recuperator 346 may be any suitable heat-exchanging device.

In a non-limiting example, the auxiliary working fluid 318 entering compressor 310 is air at approximately 140° C. The compressed auxiliary working fluid 312 exits the compressor 310 at approximately 350° C. The auxiliary working fluid 312 enters the receiver 120 and is heated to a temperature in the range of approximately 950-1000° C. The auxiliary working fluid 312 is expended within turbine expender 318 and exits therefrom at a temperature of approximately 650° C. The expended auxiliary working fluid 312 enters the recuperator 346 and thereby heats auxiliary working fluid 312 flowing from blower 160 at a temperature in the range of approximately 240-370° C. to a temperature of approximately 600° C. The heated auxiliary working fluid 312 exits recuperator 346 at an elevated temperature of approximately 620° C. and flows back to compressor 310. The heated auxiliary working fluid 312 flows into superheater 150 at a temperature of approximately 600° C. and flows thereon as described hereinabove in reference to FIG. 2.

It is noted that a single solar receiver 120 may be used along with turbine expander 318 or a plurality of solar receivers 120 and turbine expanders 318 may be utilized, as seen in FIG. 3.

Providing a plurality of solar concentrating systems provides an increased flow rate of the heat transfer fluid flowing therefrom to the turbine 172. Thus the electrical output of the turbine 172 increases. Typically, ten to a few hundred solar concentrating systems may be employed. In a non-limiting example, wherein a single solar concentrating system is employed using a dish 124 of a surface area of about 480 m² the electrical output of the turbine 172 is approximately 90-120 Kilowatt. Whereas, wherein a hundred solar power plants are employed, the electrical output of the turbine 172 is approximately 25 Megawatt.

Additionally, use of dish 124 along with the solar receiver 120 for concentrating the solar radiation in the plurality of solar concentrating systems allows for selecting the number of solar concentrating systems 104 according to a desired output of turbine 172. This is due to the relatively few components needed for sun-tracking and concentrating the solar radiation, i.e., mainly the dish 124 and solar receiver 120, which provide for enhanced modularity of the solar concentrating systems 104.

Selection of the number of solar concentrating systems in accordance with the desired output of a turbine 172 enables structuring a solar cycle system in accordance with the geographical conditions of a specific location of the solar cycle system. For example, in areas wherein the annual direct solar radiation emitted from the sun is of relatively low intensity, a relatively high number of solar concentrating systems may be employed, compared to an area with more annual direct solar radiation, so as to compensate for the relatively low solar intensity. In contrast, in an area wherein the annual solar radiation emitted from the sun is of relatively high intensity, the number of solar concentrating systems 104 selected may be lower than in other areas.

Additionally, it is known in the art that each turbine is designated to perform with maximal efficiency at a predetermined flow rate of incoming heated working fluid. Thus selection of the number of the solar concentrating systems enables structuring a solar cycle system in accordance with a desired predetermined flow rate suitable for a specific selected turbine, thereby ensuring that the turbine will perform at maximal efficiency.

Generally, providing the thermal generation system 10 with a plurality of solar concentrating systems including dish 124 along with the solar receiver 120 allows for selecting the number of solar concentrating systems according to a desired output of a thermal consumption system 50. This is due to the relatively few components needed for sun-tracking and concentrating the solar radiation, i.e., mainly the dish 124 and solar receiver 120, which provide for enhanced modularity of the solar concentrating systems 104.

Selection of the number of solar concentrating systems in accordance with the desired output of a thermal consumption system 50 enables structuring a thermal generation system 10 in accordance with the geographical conditions of a specific location of the thermal generation system 10. For example, in areas wherein the annual direct solar radiation emitted from the sun is of relatively low intensity, a relatively high number of solar concentrating systems may be employed, compared to an area with more annual direct solar radiation, so as to compensate for the relatively low solar intensity. In contrast, in an area wherein the annual solar radiation emitted from the sun is of relatively high intensity, the number of solar concentrating systems selected may be lower than in other areas.

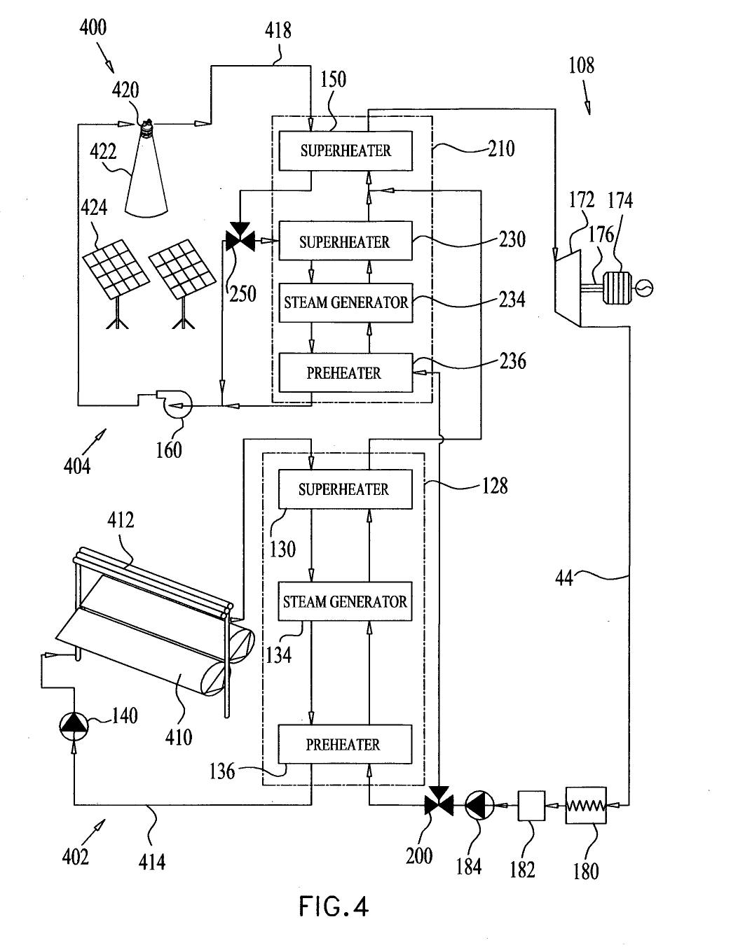

As seen in FIG. 4, the thermal generation system 10 comprises a solar cycle system 400. The first renewable energy system 20 comprises a linear Fresnel solar energy system 402. The second renewable energy system 30 comprises an auxiliary solar concentrating system configured as a solar tower system 404. The Fresnel system 402 and solar tower system 404 are in fluid communication with the vapor power generating system 108 for generating electricity therefrom.

The Fresnel system 402 may be a standard linear Fresnel solar energy system, typically comprising linear Fresnel reflectors 410 provided to concentrate solar radiation onto receivers so as to heat the first working fluid 40, comprising a Fresnel system working fluid 414, flowing therein and heated thereby. The receivers are generally formed as tubes 412 wherein the Fresnel system working fluid 414 flows therein. The Fresnel system working fluid 414 may be any suitable fluid, typically water, oil or molten salt, for example.

The Fresnel system working fluid 414 flows into the Fresnel system 402 at an initial entrance temperature so as to be heated therein and exit therefrom at a higher exit temperature than the entrance temperature.

The solar tower system 404 is operative to heat the second working fluid 60, comprising a solar tower working fluid 418, flowing therein at an initial entrance temperature. The solar tower working fluid 418 is heated by concentrated solar radiation and exits therefrom at a higher exit temperature than the entrance temperature.

The solar tower system 404 typically comprises a solar receiver 420 located on a tower 422 operative to heat the solar tower working fluid 418 by concentrated solar radiation. The solar radiation may be concentrated by any suitable means, such as by an array of heliostats 424.

Any suitable solar tower working fluid 418 may flow within the solar tower system 404, such as a gas, typically air or carbon dioxide, or a liquid such as oil, water or molten salt, for example.

The Fresnel system 402 and the solar tower system 404 are both in fluid communication with the vapor power generating system 108 for producing electricity therefrom. The heat transfer fluid 44 flows within the vapor power generating system 108 and is heated by thermal energy provided by the heated Fresnel system working fluid 414 of Fresnel system 402 and/or the heated solar tower working fluid 418 of solar tower system 404. The heat transfer fluid 44 is heated by the thermal energy, provided by the heated Fresnel system working fluid 414, to a first elevated temperature and is further heated by the thermal energy, provided by the solar tower working fluid 418, to a greater second elevated temperature, prior to entering the vapor power generating system 108.

The other features of the solar cycle system 400 may be similar to the features described in reference to solar cycle system 100 and 300 of respective FIGS. 2 and 3, mutatis mutandis.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1-32. (canceled)

33. A thermal generation system comprising:
a first renewable energy system operative to heat a first working fluid flowing therein;
a second renewable energy system operative to heat a second working fluid flowing therein; and
a heat transfer fluid for providing a thermal energy consumption system with thermal energy,
said heat transfer fluid being designated to be heated by thermal energy, provided by said heated first working fluid, to a first elevated temperature and said heat transfer fluid being designated to be heated by thermal energy, provided by said heated second working fluid, to a second elevated temperature, wherein said second elevated temperature is greater than said first elevated temperature,
said thermal energy of said heat transfer fluid being provided to said thermal energy consumption system following heating of said heat transfer fluid by said second working fluid or said first working fluid.

34. A thermal generation system according to claim 33 wherein said heat transfer fluid is heated by thermal energy provided by said first working fluid within a first heat exchanger assembly in fluid communication with said first renewable energy system.

35. A thermal generation system according to claim 33 wherein said heat transfer fluid is heated by thermal energy provided by said second working fluid within a second heat exchanger assembly in fluid communication with said second renewable energy system.

36. A thermal generation system according to claim 33 wherein said heat transfer fluid bypasses said first renewable energy system and is heated within said second renewable energy system.

37. A thermal generation system according to claim 33 wherein said first renewable energy system and said second renewable energy system comprise any one of a solar energy systems, a solar tower system, a Fresnel lens solar energy system, a trough-Fresnel mirror solar energy system, a linear Fresnel solar energy system, a solar dish concentrating energy system, a solar heliostat concentrating energy system, a parabolic trough solar concentrating energy system, a geothermal energy systems, a wind energy system or a wave energy system.

38. A thermal generation system according to claim 33 wherein said thermal energy consumption system is designated to provide thermal energy for a thermal energy consumption system.

39. A thermal generation system according to claim 33 wherein said thermal energy of said thermal energy consumption system is provided for industrial systems or said thermal energy is utilized for vaporization or pasteurization, or said thermal energy is used for drying, or said thermal energy is used for drying polymer containing products, or said thermal energy is introduced into a vapor turbine for generation of electricity therefrom or said thermal energy is provided to boost a vapor turbine, or said thermal energy provides vapor to systems consuming vapor, or said thermal energy is utilized for direct heating of a solid desiccant system, a desiccant system included in an air conditioning system or said thermal energy is used for absorption cooling.

40. A thermal generation system according to claim 33 wherein said first renewable energy system comprises a single axis Sun tracking solar concentrating system and said second renewable energy system comprises a dual axis Sun tracking solar concentrating system.

41. A thermal generation system according to claim 33 wherein said second renewable energy system comprises a solar concentrating system including at least one dish and at least one solar receiver.

42. A method for providing thermal energy to a thermal energy consumption system comprising:
heating a first working fluid flowing within a first renewable energy system;
heating a second working fluid flowing within a second renewable energy system;
heating a heat transfer fluid, flowing within said thermal energy consumption system, by thermal energy provided by said heated first working fluid, to a first elevated temperature;
heating said heat transfer fluid by thermal energy, provided by said heated second working fluid, to a second elevated temperature, wherein said second elevated temperature is greater than said first elevated temperature; and
providing said thermal energy from said heat transfer fluid to said thermal energy consumption system following heating of said heat transfer fluid by said second working fluid or said first working fluid.

43. A thermal generation system comprising:
a vapor power generating system comprising a heat transfer fluid to be expanded within a turbine for generation of electricity therefrom;
a parabolic trough solar concentrating system designed to provide thermal energy to said heat transfer fluid so as to heat said heat transfer fluid to a first elevated temperature; and
an auxiliary solar concentrating system operative to provide thermal energy to said heat transfer fluid so as to further heat said heat transfer fluid to a second elevated temperature,
said second elevated temperature being greater than said first elevated temperature,
said thermal energy of said heat transfer fluid being provided to said thermal energy consumption system following heating of said heat transfer fluid by said second working fluid or said first working fluid.

44. A thermal generation system according to claim 43 wherein said auxiliary solar concentrating system comprises a dish concentrator and a solar receiver.

45. A thermal generation system according to claim 43 wherein said auxiliary solar concentrating system comprises a plurality of dish concentrators and solar receivers.

46. A thermal generation system according to claim 43 wherein at least one compressor and at least one additional turbine are provided.

47. A thermal generation system according to claim 43 wherein said heat transfer fluid is heated by thermal energy, provided by said parabolic trough solar concentrating system, by a trough system working fluid flowing within said parabolic trough solar concentrating system, and said heat transfer fluid is heated by thermal energy, provided by said auxiliary solar concentrating system, by an auxiliary working fluid flowing within said auxiliary solar concentrating system.

48. A thermal generation system according to claim 47 wherein said heat transfer fluid is heated by thermal energy provided by said trough system working fluid, flowing within a first heat exchanger assembly, and said heat transfer fluid is heated by thermal energy provided by said auxiliary working fluid, flowing within a second heat exchanger assembly.

49. A thermal generation system according to claim 48 wherein said first heat exchanger assembly comprises a preheater, a steam generator and/or a superheater.

50. A thermal generation system according to claim 48 wherein said second heat exchanger assembly comprises a primary superheater.

51. A thermal generation system according to claim 48 wherein said second heat exchanger assembly comprises a preheater, a steam generator and/or an additional superheater.

52. A thermal generation system according to claim 51 wherein said heat transfer fluid flows from said turbine to said first heat exchanger assembly and thereafter to said primary superheater within said second heat exchanger assembly.

53. A thermal generation system according to claim 51 wherein said heat transfer fluid flows from said turbine to said preheater of said second heat exchanger assembly.

54. A thermal generation system according to claim 43 wherein said parabolic trough solar concentrating system comprises a parabolic trough reflector provided to concentrate solar radiation onto tubes.

55. A method for providing thermal energy to a thermal energy consumption system comprising:
heating a trough system working fluid flowing within a parabolic trough solar concentrating system;
heating an auxiliary working fluid flowing within an auxiliary solar concentrating system;
heating a heat transfer fluid, flowing within said thermal energy consumption system, by thermal energy provided by said heated trough system working fluid, to a first elevated temperature;
heating said heat transfer fluid by thermal energy provided by said heated auxiliary working fluid to a second elevated temperature, wherein said second elevated temperature is greater than said first elevated temperature; and
providing said thermal energy from said heat transfer fluid to said thermal energy consumption system following heating of said heat transfer fluid by said second working fluid or said first working fluid.

56. A method according to claim 55 wherein said thermal energy consumption system comprises a turbine and said heat transfer fluid is expanded therein, thereby generating electricity.

57. A thermal generation system comprising:
a single axis Sun tracking solar concentrating system including a solar concentrator for concentrating solar radiation so as to heat a first working fluid flowing therein,
said single axis Sun tracking solar concentrating system being operative to follow the Sun by tracking along a single axis of said single axis Sun tracking solar concentrating system;
a plural axis Sun tracking solar concentrating system including a solar concentrator for concentrating solar radiation so as to heat a second working fluid flowing therein,
said plural axis Sun tracking solar concentrating system being operative to follow the Sun by tracking along at least two axes of said plural axis Sun tracking solar concentrating system; and
a heat transfer fluid for providing a thermal energy consumption system with thermal energy,
said heat transfer fluid being designated to be heated by thermal energy, provided by said heated first working fluid, to a first elevated temperature and said heat transfer fluid being designated to be heated by thermal energy, provided by said heated second working fluid, to a second elevated temperature,
said thermal energy of said heat transfer fluid being provided to said thermal energy consumption system following heating of said heat transfer fluid by said second working fluid or said first working fluid.

58. A thermal generation system according to claim 57 wherein said second elevated temperature is greater than said first elevated temperature.

59. A thermal generation system according to claim 57 wherein said single axis Sun tracking solar concentrating system comprises a parabolic trough solar concentrating system and said plural axis Sun tracking solar concentrating system comprises a solar concentrating system comprising at least one dish and at least one solar receiver.

60. A method for providing thermal energy to a thermal energy consumption system comprising:
heating a first working fluid flowing within a single axis Sun tracking solar concentrating system;
heating a second working fluid flowing within a plural axis Sun tracking solar concentrating system;
heating a heat transfer fluid, flowing within said thermal energy consumption system, by thermal energy provided by said heated first working fluid, to a first elevated temperature;
heating said heat transfer fluid, by thermal energy provided by said heated second working fluid, to a second elevated temperature; and
providing said thermal energy from said heat transfer fluid to said thermal energy consumption system following heating of said heat transfer fluid by said second working fluid or said first working fluid.

61. A method according to claim 60 wherein said second elevated temperature is greater than said first elevated temperature.
